(19) United States
(12) Patent Application Publication
(10) Pub. No.: US 2026/0248168 A1
(43) Pub. Date: Aug. 27, 2026

(54) TOFU MANUFACTURING APPARATUS

(71) Applicants: House Foods Corporation, Osaka (JP); House Foods Group Inc., Osaka (JP)

(72) Inventors: Hidenori ISOBE, Osaka (JP); Yoshihito ASAMI, Osaka (JP); Yoshikage GOTO, Osaka (JP); Takuya WADA, Osaka (JP)

(73) Assignees: House Foods Corporation, Osaka (JP); House Foods Group Inc., Osaka (JP)

(21) Appl. No.: 19/551,868

(22) Filed: Feb. 27, 2026

(30) Foreign Application Priority Data
Feb. 27, 2025 (JP) JP2025-030420

(51) Int. Cl. A23P 30/10; A23L 11/45

(52) U.S. Cl. CPC A23P 30/10; A23L 11/45

(57) ABSTRACT

A tofu manufacturing apparatus is provided that can more easily control firmness of tofu while preventing decrease in yield. A tofu manufacturing apparatus includes: a coagulation machine that produces coagulated soymilk T that is tofu dough; a cutting unit that cuts the coagulated soymilk T in the coagulation machine into a polyhedral shape; a conveying machine that conveys the coagulated soymilk T downstream, the coagulated soymilk T having been cut into a polyhedral shape by the cutting unit; a collapse prevention unit that is provided in at least one of the coagulation machine and the conveying machine and prevents collapse of the coagulated soymilk T; and a forming machine that compression-forms the coagulated soymilk T conveyed from the conveying machine.

### CROSS-REFERENCE TO RELATED APPLICATIONS

The present application claims the benefit of priority from the specification of Japanese Patent Application No. 2025-030420, filed on February 27, 2025, which specification is incorporated herein by reference in its entirety.

### TECHNICAL FILED

The present disclosure relates to a tofu manufacturing apparatus.

### DISCUSSION OF THE BACKGROUND

The description in this section merely provides information of background related to the present disclosure, and may not necessarily constitute the prior art.

For example, tofu is produced by subjecting soybeans to processes such as immersing, crushing, heating, squeezing, coagulating, and pressing.

For example, Japanese Patent No. 5635964 discloses a batch type coagulation apparatus for tofu in which stirring means uniformly break matured coagulated soymilk and coagulated soymilk discharge means discharges the soymilk to a subsequent forming process. It also discloses that the stirring means also serves as breaking means for uniformly and roughly breaking the matured coagulated soymilk.

### SUMMARY

In a case of breaking coagulated soymilk with stirring means, it is difficult to control the firmness of cotton tofu. Furthermore, if the coagulated soymilk is collapsed too much, water will be removed excessively from the collapsed coagulated soymilk through pressing, and a size of cotton tofu manufactured from the same amount of coagulated soymilk decreases, making the yield lower and the tofu itself firmer.

In light of the above-described problems, the present disclosure aims to provide a tofu manufacturing apparatus that makes it easier to adjust firmness of tofu in a forming machine while preventing decrease in yield.

To solve the above problems, a tofu manufacturing apparatus according to a first aspect of the present disclosure includes: a coagulation machine that produces coagulated soymilk that is tofu dough; a cutting unit that cuts the coagulated soymilk in the coagulation machine into a polyhedral shape; a conveying machine that conveys the coagulated soymilk downstream, the coagulated soymilk having been cut into a polyhedral shape by the cutting unit; a collapse prevention unit that is provided in at least one of the coagulation machine and the conveying machine and prevents collapse of the coagulated soymilk; and a forming machine that compression-forms the coagulated soymilk conveyed from the conveying machine.

Furthermore, according to the tofu manufacturing apparatus of a second aspect of the present disclosure, in relation to the first aspect, the collapse prevention unit has an electric actuator or a hydraulic or pneumatic actuator that tilts the coagulation machine to discharge the coagulated soymilk in the coagulation machine onto the conveying machine, and the actuator is capable of controlling a tilt speed in accordance with a tilt angle of the coagulation machine.

Furthermore, according to the tofu manufacturing apparatus of a third aspect of the present disclosure, in relation to the second aspect, the actuator tilts the coagulation machine at a faster tilting speed before the coagulated soymilk in the coagulation machine is discharged, and tilts the coagulation machine in multiple stages at a slower tilting speed once the coagulated soymilk in the coagulation machine begins to be discharged, to control a discharge speed of the coagulated soymilk.

Furthermore, according to the tofu manufacturing apparatus of a fourth aspect of the present disclosure, in relation to the first aspect, the collapse prevention unit has a hopper provided on the conveying machine, and the hopper has an inclined surface that receives the coagulated soymilk discharged from the coagulation machine, the inclined surface having an inclination angle that increases from downstream to upstream in a conveying direction.

Furthermore, according to the tofu manufacturing apparatus of a fifth aspect of the present disclosure, in relation to the second aspect, the collapse prevention unit has a hopper provided on the conveying machine, and the hopper has an inclined surface that receives the coagulated soymilk discharged from the coagulation machine, the inclined surface having an inclination angle that increases from downstream to upstream in a conveying direction.

Furthermore, according to the tofu manufacturing apparatus of a sixth aspect of the present disclosure, in relation to the third aspect, the collapse prevention unit has a hopper provided on the conveying machine, and the hopper has an inclined surface that receives the coagulated soymilk discharged from the coagulation machine, the inclined surface having an inclination angle that increases from downstream to upstream in a conveying direction.

Furthermore, according to the tofu manufacturing apparatus of a seventh aspect of the present disclosure, in relation to the fourth aspect, the collapse prevention unit includes a rotary pump connected to a discharge outlet of the hopper, and conveys the coagulated soymilk to the forming machine using a pressure of the rotary pump.

Furthermore, according to the tofu manufacturing apparatus of an eighth aspect of the present disclosure, in relation to the seventh aspect, the collapse prevention unit has a conveying pipe having one end connected to the rotary pump and another end reaching the forming machine.

Furthermore, according to the tofu manufacturing apparatus of a ninth aspect of the present disclosure, in relation to the eighth aspect, the conveying pipe includes a food-grade hose, a bend pipe, and a straight pipe.

Furthermore, according to the tofu manufacturing apparatus of a tenth aspect of the present disclosure, in relation to the eighth aspect, the coagulation machine, the conveying machine, and the forming machine are positioned adjacently to one another to have a configuration such that the conveying pipe is relatively short.

Furthermore, according to the tofu manufacturing apparatus of an eleventh aspect of the present disclosure, in relation to the fourth aspect, the collapse prevention unit has a chute included in the conveying machine, and the chute delivers the coagulated soymilk discharged from the coagulation machine to the hopper.

Furthermore, according to the tofu manufacturing apparatus of a twelfth aspect of the present disclosure, in relation to the first aspect, the cutting unit has a lattice-shaped vertical cutter that vertically cuts the coagulated soymilk in the coagulation machine, and a horizontal cutter that horizontally cuts the coagulated soymilk.

Furthermore, according to the tofu manufacturing apparatus of a thirteenth aspect of the present disclosure, in relation to the second aspect, the cutting unit has a lattice-shaped vertical cutter that vertically cuts the coagulated soymilk in the coagulation machine, and a horizontal cutter that horizontally cuts the coagulated soymilk.

Furthermore, according to the tofu manufacturing apparatus of a fourteenth aspect of the present disclosure, in relation to the third aspect, the cutting unit has a lattice-shaped vertical cutter that vertically cuts the coagulated soymilk in the coagulation machine, and a horizontal cutter that horizontally cuts the coagulated soymilk.

Furthermore, according to the tofu manufacturing apparatus of a fifteenth aspect of the present disclosure, in relation to the first aspect, the coagulation machine is a round-type bucket coagulation machine in which multiple coagulation buckets circle around a base stage.

Furthermore, according to the tofu manufacturing apparatus of a sixteenth aspect of the present disclosure, in relation to the second aspect, the coagulation machine is a round-type bucket coagulation machine in which multiple coagulation buckets circle around a base stage.

Furthermore, according to the tofu manufacturing apparatus of a seventeenth aspect of the present disclosure, in relation to the third aspect, the coagulation machine is a round-type bucket coagulation machine in which multiple coagulation buckets circle around a base stage.

Furthermore, according to the tofu manufacturing apparatus of an eighteenth aspect of the present disclosure, in relation to the first aspect, the forming machine is a continuous forming device that compression-forms coagulated soymilk supplied to a conveyance passage.

Furthermore, according to the tofu manufacturing apparatus of a nineteenth aspect of the present disclosure, in relation to the second aspect, the forming machine is a continuous forming device that compression-forms coagulated soymilk supplied to a conveyance passage.

Furthermore, according to the tofu manufacturing apparatus of a twentieth aspect of the present disclosure, in relation to the third aspect, the forming machine is a continuous forming device that compression-forms coagulated soymilk supplied to a conveyance passage.

### Advantageous Effects of Invention

The tofu manufacturing apparatus of the present disclosure makes it easier to adjust the firmness of tofu in a continuous forming machine while preventing decrease in yield.

### BRIEF DESCRIPTION OF THE DRAWINGS

FIG. 1 is a schematic front view showing main portions of a tofu manufacturing apparatus according to an embodiment of the present disclosure.

FIG. 2 is a schematic plan view showing the main portions of the tofu manufacturing apparatus according to the embodiment of the present disclosure.

FIG. 3 is a schematic plan view of a bucket-type coagulation machine according to the embodiment of the present disclosure.

FIG. 4 is a schematic front view of a conveying machine and a continuous forming device according to the embodiment of the present disclosure.

FIG. 5 is a schematic side view of the device as viewed from a direction of an arrow in FIG. 4.

FIG. 6 is a schematic plan view of the device shown in FIG. 4.

FIG. 7 is a schematic diagram showing a cutting unit of the tofu manufacturing apparatus.

FIG. 8 is a diagram showing how a tilt speed is controlled in accordance with a tilt angle of the coagulation machine using an actuator.

FIG. 9 is a diagram showing an example of a schematic overall configuration of the continuous forming device for tofu according to the embodiment of the present disclosure.

FIG. 10 is a diagram showing a cross section taken along line II-II in FIG. 9.

### DETAILED DESCRIPTION OF EMBODIMENTS

An embodiment of the present disclosure will be described below with reference to the accompanying drawings. To facilitate understanding, identical components throughout the drawings are denoted by the same reference numerals and characters whenever possible, and redundant descriptions will be omitted as appropriate.

### Embodiment

### Configuration of Tofu Manufacturing Apparatus

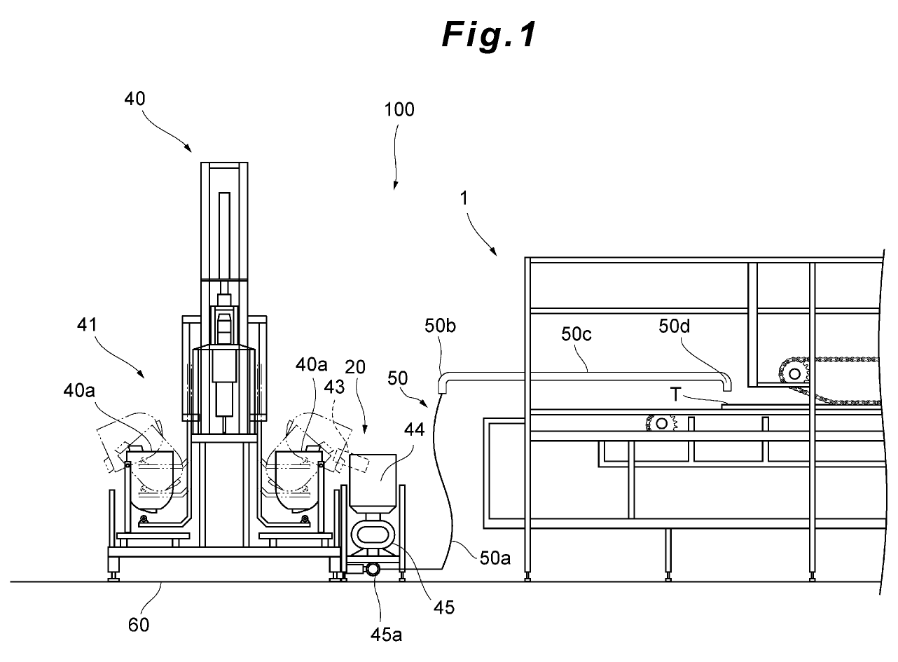

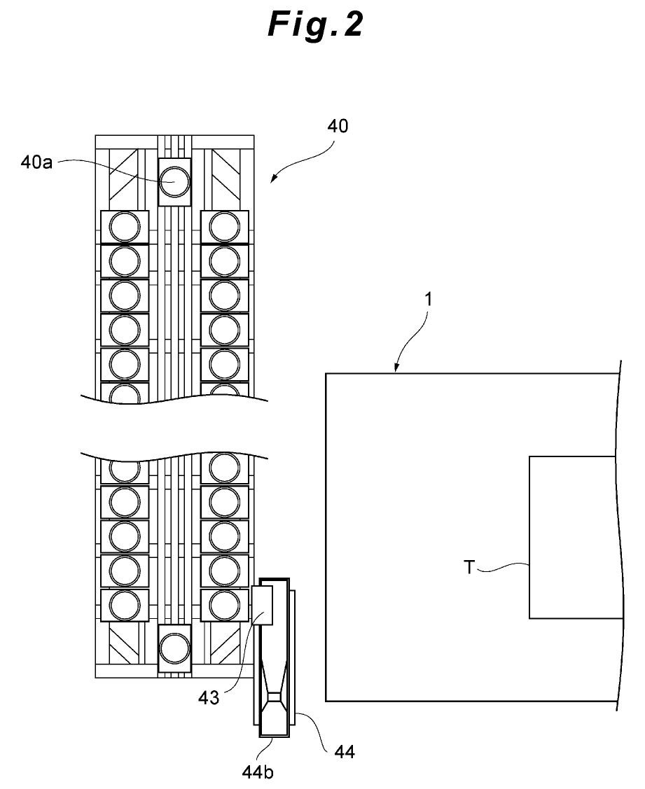

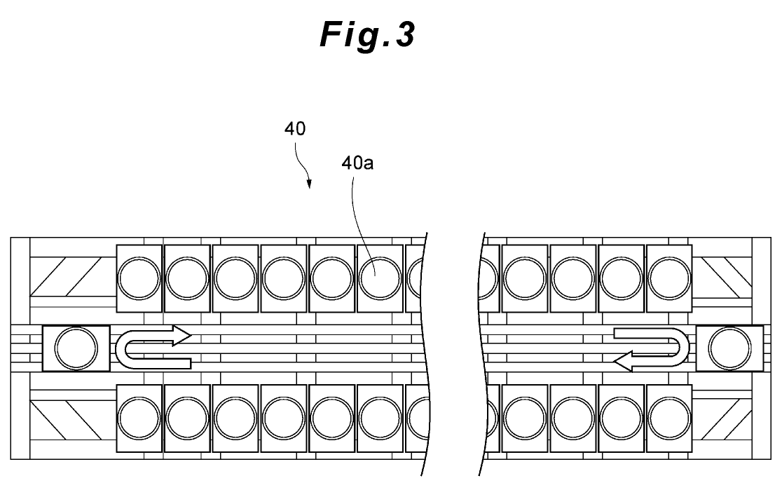

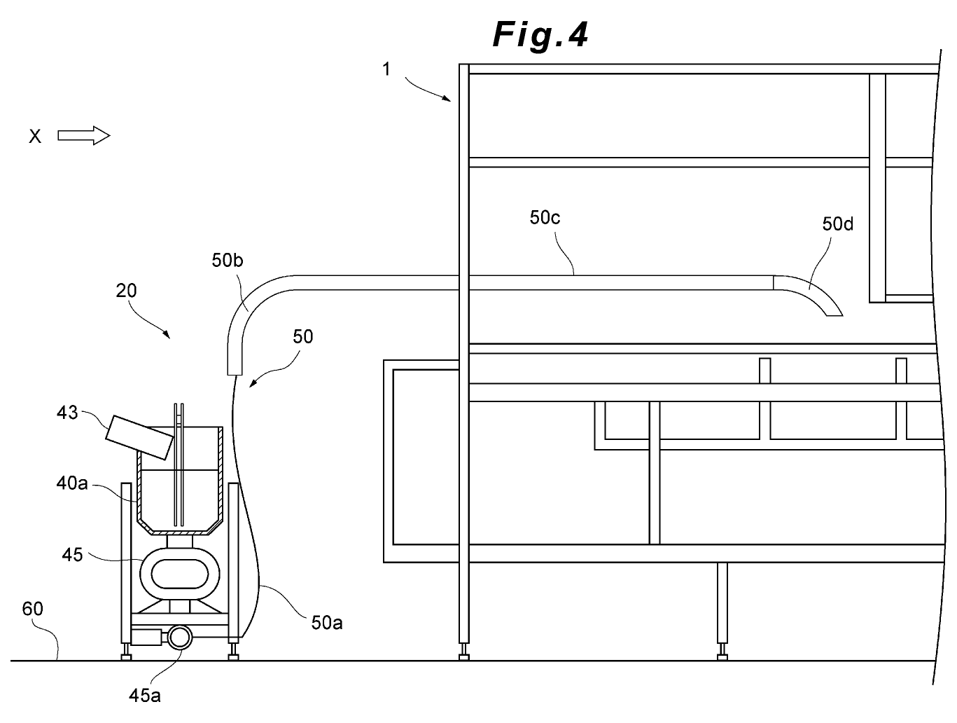

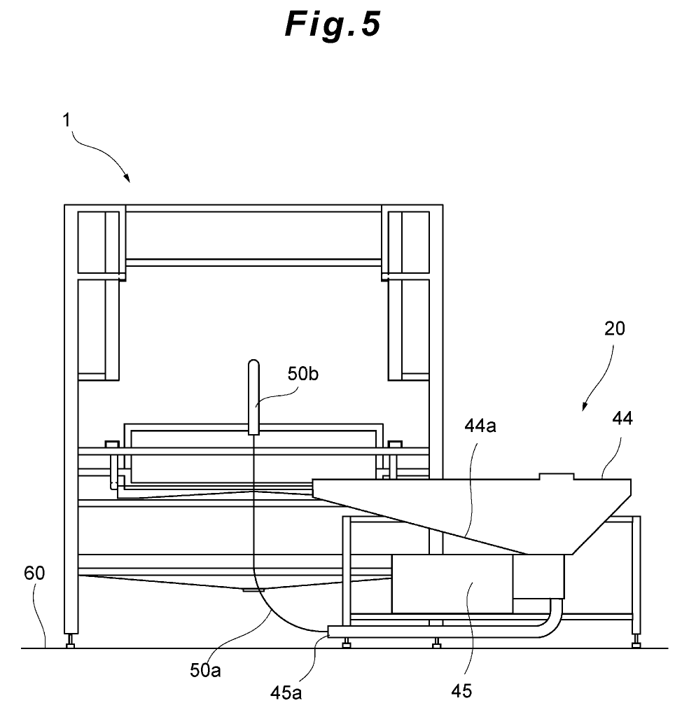

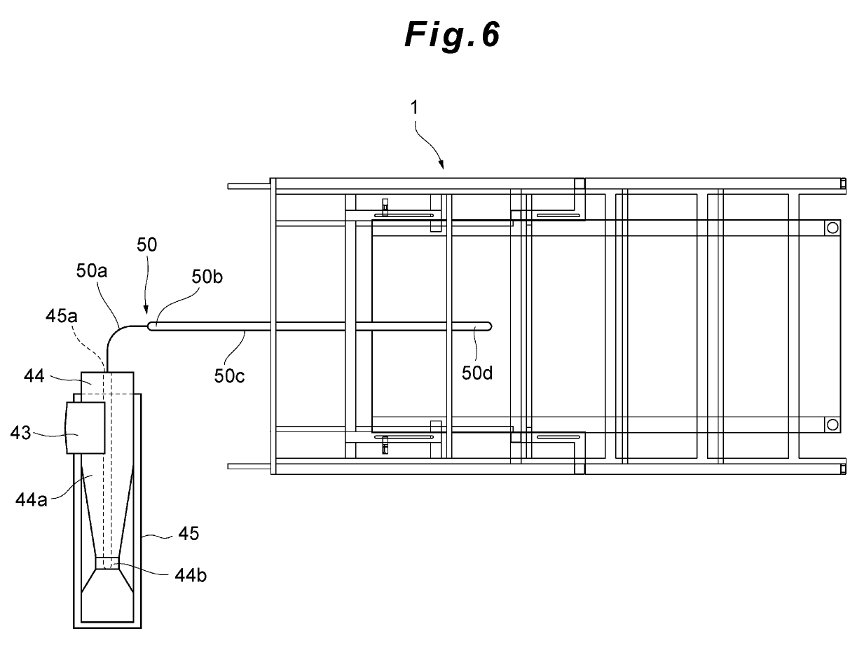

FIG. 1 is a schematic front view showing main portions of a tofu manufacturing apparatus 100 according to an embodiment of the present disclosure, and FIG. 2 is a schematic plan view of the tofu manufacturing apparatus 100. FIG. 3 is a schematic plan view of a bucket-type coagulation machine 40 according to the embodiment of the present disclosure. FIG. 4 is a schematic front view of a conveying machine 20 and a continuous forming device 1 according to the embodiment of the present disclosure, FIG. 5 is a schematic side view of the device as viewed from the direction of arrow X in FIG. 4, and FIG. 6 is a schematic plan view of the device shown in FIG. 4.

As shown in FIGS. 1 and 2, the tofu manufacturing apparatus 100 includes: the bucket-type coagulation machine 40 that produces coagulated soymilk T, which is tofu dough; the conveying machine 20 that conveys the coagulated soymilk T downstream from the coagulation machine 40, the coagulated soymilk T having been cut into a polyhedral shape by a cutting unit 42; a collapse prevention unit provided in the coagulation machine 40 and/or the conveying machine 20 that prevents the coagulated soymilk T from collapsing; and the continuous forming device 1 that compression-forms the coagulated soymilk T conveyed from the conveying machine 20. Here, a polyhedron is a solid body surrounded by four or more planar polygons, and includes a tetrahedron, pentahedron, and hexahedron. The tofu manufacturing apparatus 100 according to the embodiment of the present disclosure can convey the coagulated soymilk T produced in the coagulation machine 40 and cut into a polyhedral shape to the continuous forming device 1 while minimizing collapse. The conveying machine 20 is located between the coagulation machine 40 and the continuous forming device 1, and conveys the coagulated soymilk T from the coagulation machine 40 to the continuous forming device 1. Hereinafter, the coagulation machine 40 will also be referred to as a bucket coagulation machine 40 as appropriate.

As shown in FIG. 3, the bucket coagulation machine 40 is configured as a round-type bucket coagulation machine in which multiple coagulation buckets 40a circle around a base stage 41. The round-type bucket coagulation machine tilts the coagulation buckets 40a to discharge the coagulated soymilk T inside. In this embodiment, the bucket coagulation machine 40 has multiple coagulation buckets 40a, and each coagulation bucket 40a is rotated and conveyed clockwise from the most upstream position to the most downstream position to make one circuit around the base stage 41.

Specifically, soymilk is poured into the coagulation bucket 40a at the most upstream position, and a coagulating agent is added to the coagulation bucket 40a at a more downstream position and stirred with the soymilk. This causes the soymilk to begin to coagulate. The coagulation bucket 40a is then conveyed further around the base stage 41. At a further downstream position, the coagulated soymilk T is cut and broken by elevating and lowering the cutting unit 42, and then cut and broken at a further downstream position by the rotation of the cutting unit 42. The coagulation bucket 40a is further conveyed around the base stage 41, and at a further downstream position, the coagulated soymilk T in the bucket is deposited into a hopper 44, which is also part of the collapse prevention unit, via a chute 43, which is also part of the collapse prevention unit. The most upstream position and the most downstream position can be set optionally.

The collapse prevention unit is a characteristic portion provided in the bucket coagulation machine 40 and/or the conveying machine 20 that prevents the coagulated soymilk T from collapsing.

As shown in FIGS. 1 and 2, the tofu manufacturing apparatus 100 has the chute 43 included in the conveying machine 20 as the collapse prevention unit, and the chute 43 smoothly delivers the coagulated soymilk T discharged from the coagulation bucket 40a of the bucket coagulation machine 40 to the hopper 44. The chute 43 has a width greater than the diameter of the coagulation bucket 40a to receive the coagulated soymilk T discharged from the tilted coagulation bucket 40a, and has a surface for receiving the coagulated soymilk T formed smoothly. As shown in FIGS. 1 and 4, the chute 43 is fixed to the hopper 44 so as to protrude from a housing of the hopper 44 toward the coagulation bucket 40a, and is gently inclined downward from the coagulation bucket 40a side toward the hopper 44. Because the coagulated soymilk T is not discharged directly into the hopper 44 but is temporarily received by the chute 43 and then gently delivered to the hopper 44, collapse of the coagulated soymilk T caused by the impact when it falls to the bottom of the hopper 44 is prevented.

As shown in FIGS. 2 and 5, the tofu manufacturing apparatus 100 also has the hopper 44 included in the conveying machine 20 as the collapse prevention unit. The hopper 44 has an inclined surface 44a that receives the coagulated soymilk T discharged from the bucket coagulation machine 40 or the chute 43, and the inclined surface 44a has an inclination angle that increases from downstream to upstream in a conveying direction, for example, an inclination angle of 15° to 20°. The inclined surface 44a is part of the bottom surface of the hopper 44. In other words, the inclined surface 44a is located at a higher position at a point corresponding to the position where the coagulated soymilk T in the bucket is deposited into the hopper 44, and the inclined surface 44a is located at a lower position at a discharge outlet 44b for the coagulated soymilk T, which is downstream of the point. The discharge outlet 44b is located at the lowest position at the bottom of the coagulation bucket 40a.

In this way, since the hopper 44 has the inclined surface 44a having an inclination angle of 15° to 20° from downstream to upstream in the conveying direction, the coagulated soymilk T is prevented from stagnating inside the hopper 44, and flows smoothly downstream. Furthermore, after the tofu manufacturing apparatus 100 is put into operation and the first coagulated soymilk T is deposited in the hopper 44, the first coagulated soymilk T accumulated in the hopper 44 acts as a cushion, further preventing the subsequent coagulated soymilk T from collapse when it falls onto the inclined surface 44a. Contrarily, if the inclined surface 44a of the hopper 44 has an inclination angle of 10° or less, the coagulated soymilk T will stagnate and will not easily flow downstream.

Here, the inclined surface 44a of the hopper 44 may be fixed in a range of 15° to 20°, or the inclination angle may be adjustable in multiple stages. For example, the hopper 44 may be configured so that the inclination angle of the inclined surface 44a of the hopper 44 is adjustable in three stages: 15°, 17.5°, and 20°.

Furthermore, the hopper 44 has a capacity more than twice that of one coagulation bucket 40a. As a result, the impact of the falling of the subsequent coagulated soymilk T is cushioned by the coagulated soymilk T that has accumulated earlier in the hopper 44, preventing the subsequent coagulated soymilk T from collapse. Furthermore, as shown in FIG. 4, the discharge outlet 44b for the coagulated soymilk T is located at the lowest position at the bottom of the coagulation bucket 40a, so that the coagulated soymilk T accumulated earlier is discharged earlier from the hopper 44, and the coagulated soymilk T accumulated later is discharged later from the hopper 44, preventing the freshness of the coagulated soymilk T from being lost.

As shown in FIGS. 1, 4, and 5, the tofu manufacturing apparatus 100 has a rotary pump 45, as the collapse prevention unit, connected to the discharge outlet 44b of the hopper 44, and conveys the coagulated soymilk T to the continuous forming device 1 by the pressure of the rotary pump 45. Specifically, by using a large-sized rotary pump to avoid collapse during pumping, sufficient suction force can be obtained to lift the coagulated soymilk T upward and convey it to the continuous forming device 1. The rotary pump 45 is connected below the hopper 44, rather than to the coagulation bucket 40a, and suctions up the coagulated soymilk T accumulated in the hopper 44 and conveys it to the continuous forming device 1 through a conveying pipe 50. The rotary pump 45 is vertically close to the discharge outlet 44b of the hopper 44 and connected thereto, keeping the vertical movement distance of the coagulated soymilk T from the hopper 44 to the rotary pump 45 short. Therefore, collapse of the coagulated soymilk T is prevented when the coagulated soymilk T is moved from the hopper 44 to the conveying pipe 50 by the suction force of the rotary pump 45. Furthermore, the rotary pump 45 is located at a short distance from a floor surface 60.

The tofu manufacturing apparatus 100 also has the conveying pipe 50, as the collapse prevention unit, one end of which is connected to the rotary pump 45 and the other end of which reaches the continuous forming device 1. Specifically, the conveying pipe 50 includes a food-grade hose 50a connected to a discharge port 45a of the rotary pump 45, a bend pipe 50b connected to the other end of the food-grade hose 50a, a straight pipe 50c connected to the bend pipe 50b, and a bend pipe 50d connected to the straight pipe 50c. By using the bend pipe, which has a more gradual bend than an elbow pipe, pressure loss can be reduced and the coagulated soymilk T can be prevented from colliding with the bent corner of the vent pipe and collapsing.

The food-grade hose 50a is made of a lightweight material such as polyvinyl chloride and is flexible. Therefore, the food-grade hose 50a can be easily connected to the discharge port 45a of the rotary pump 45 and the bend pipe 50b. The bend pipe 50d is located above a conveyance passage 4 of the continuous forming device 1, which will be described later, so that the coagulated soymilk T is conveyed to the continuous forming device 1 through the inside of the conveying pipe 50.

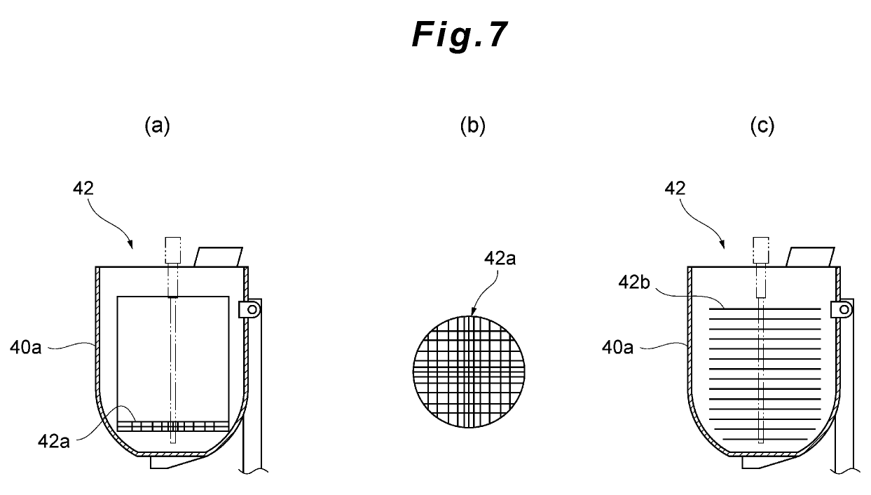

FIG. 7 is a schematic diagram showing the cutting unit 42 of the tofu manufacturing apparatus 100. FIG. 7(a) is a schematic side view of a vertical cutter 42a serving as the cutting unit 42, FIG. 7(b) is a schematic plan view of the vertical cutter 42a, and FIG. 7(c) is a schematic side view of a horizontal cutter 42b serving as the cutting unit 42.

The cutting unit 42 has the lattice-shaped vertical cutter 42a that is elevated and lowered to vertically cut the coagulated soymilk T in the coagulation bucket 40a of the bucket coagulation machine 40, and the horizontal cutter 42b that is rotated to horizontally cut the coagulated soymilk T. Here, “lattice-shaped” refers to a state in which partitions or dividers are arranged periodically vertically and horizontally.

With reference to FIG. 7(b), the vertical cutter 42a has a lattice size of an optional size depending on the type and quality of tofu to be manufactured, making it possible to cut (break) the coagulated soymilk T to an optional size.

With reference to FIG. 7(c), the horizontal cutter 42b has a rotating shaft and multiple rod-shaped members fixed to the rotating shaft at equal vertical intervals and extending horizontally. The horizontal cutter 42b is a jig having a fishbone shape. The vertical intervals between the rod-shaped members can be set optionally depending on the type and quality of tofu to be manufactured.

By matching the lattice size of the vertical cutter 42a with each interval between the rod-shaped members, the coagulated soymilk T is cut into polyhedral shapes, and in particular cubic shapes, at a predetermined position around the base stage 41. However, the cut coagulated soymilk T does not need to have a cubic shape. By making the lattice size of the vertical cutter 42a different from each interval between the rod-shaped members, the cut coagulated soymilk T may be cut into a polyhedral shape, particularly a rectangular parallelepiped shape.

As shown in FIG. 7(a), at a predetermined position around the base stage 41, the lattice-shaped vertical cutter 42a is lowered vertically into the coagulation bucket 40a, thereby cutting the coagulated soymilk T vertically. Furthermore, at a further downstream position around the base stage 41, the horizontal cutter 42b is lowered vertically into the coagulation bucket 40a and rotated, thereby cutting the coagulated soymilk T horizontally. As a result, the coagulated soymilk T is cut into a polyhedral shape.

However, instead of this, the coagulated soymilk T may be cut horizontally using the horizontal cutter 42b at an upstream position, and then cut vertically using the lattice-shaped vertical cutter 42a at a downstream position, thereby cutting the coagulated soymilk T into a polyhedral shape.

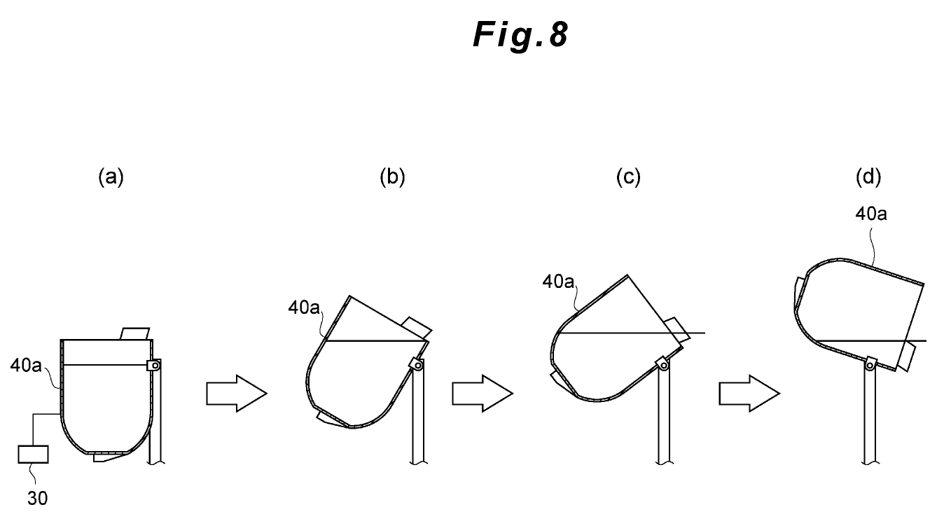

FIG. 8 is a diagram showing how a tilt speed is controlled in accordance with a tilt angle of the bucket coagulation machine 40 using an actuator 30 as the collapse prevention unit.

As shown in FIG. 8, the tofu manufacturing apparatus 100 has the actuator 30 serving as the collapse prevention unit that tilts the coagulation bucket 40a of the bucket coagulation machine 40 to discharge the coagulated soymilk T in the coagulation bucket 40a into the conveying machine 20, and the actuator 30 can control the tilt speed in accordance with the tilt angle of the bucket coagulation machine 40. Here, the actuator includes an electric actuator, or a hydraulic or pneumatic actuator.

For example, from a state in which the coagulation bucket 40a of the bucket coagulation machine 40 is oriented vertically (FIG. 8(a)) until the coagulation bucket 40a is slightly tilted around a rotation axis (not shown) and the coagulated soymilk T inside reaches the edge of the coagulation bucket 40a (FIG. 8(b)), the actuator 30 tilts the coagulation bucket 40a at a relatively fast speed. Next, after the coagulation bucket 40a is tilted further and the coagulated soymilk T begins to fall from the edge of the coagulation bucket 40a (FIG. 8(c)), the actuator 30 tilts the coagulation bucket 40a at a relatively slow speed in multiple stages to control a discharge speed of the coagulated soymilk T.

Here, “multiple stages” means that, for example, S1 > S2 > S3 holds, where: S1 is a tilt speed from when the coagulated soymilk T begins to fall from the coagulation bucket 40a until the coagulated soymilk T in the bucket becomes two-thirds of its original volume; S2 is a tilt speed until the remaining coagulated soymilk T becomes one-third; and S3 is a tilt speed until all the remaining coagulated soymilk T is gone.

In conventional designs, the coagulation machine was controlled using a single waste flow control valve, making it difficult to adjust the tilt speed and only allowing for a uniform speed change. By using multiple waste flow control valves or actuators 30, it is possible to increase the tilt speed within a range that does not affect the discharge of the coagulated soymilk T to shorten the time while slowing the tilt speed at a tilt angle at which the coagulated soymilk T is discharged, especially slowing the tilt speed in multiple stages, so that the coagulated soymilk T can be prevented from collapsing due to impact when it is discharged. In particular, by making the tilt speed at the end of the discharge the slowest, it is possible to prevent the coagulated soymilk T from collapsing due to the impact caused by the coagulated soymilk T being discharged all together at the end of the discharge.

The coagulation bucket 40a can rotate further than horizontal, for example, to the state shown in FIG. 8(d). By rotating the coagulation bucket 40a further than horizontal in this way, the coagulated soymilk T is prevented from remaining in the coagulation bucket 40a without being discharged even if the tilt speed is slow.

### Configuration of Continuous Forming Device

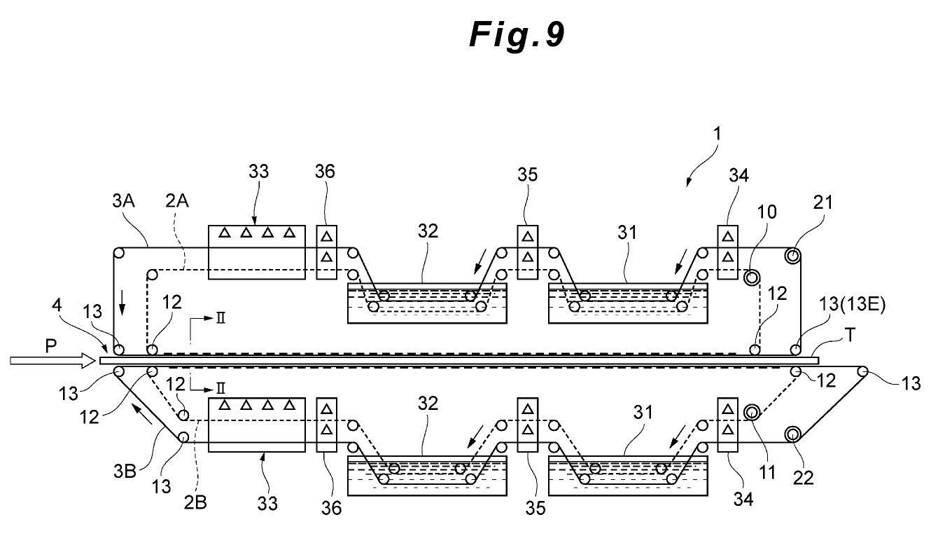

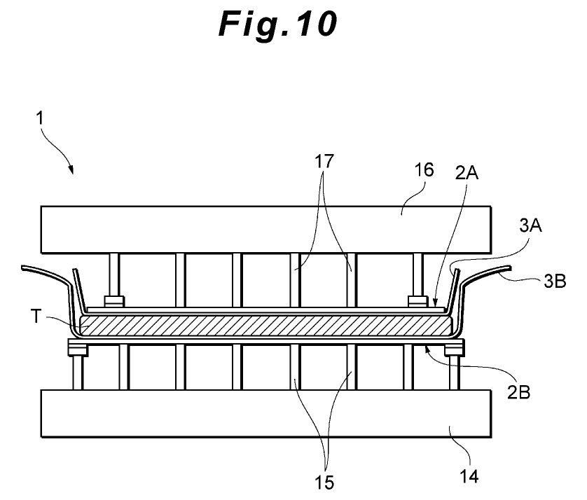

FIG. 9 is a diagram showing an example of a schematic overall configuration of the continuous forming device 1 for tofu according to the embodiment of the present disclosure. FIG. 10 is a diagram showing a cross section taken along line II-II in FIG. 9. The continuous forming device 1 for tofu is a device that compression-forms the coagulated soymilk T, which is tofu dough, supplied to the conveyance passage 4. The coagulated soymilk T is produced by adding a coagulating agent to the soymilk manufactured by the bucket coagulation machine 40 and coagulating it (primary coagulation).

The continuous forming device 1 includes a conveyor 2A, a conveyor 2B, a fabric belt 3A, and a fabric belt 3B as main components. The conveyor 2A serves as a first conveyor, and the conveyor 2B serves as a second conveyor. The fabric belt 3A serves as a first fabric belt, and the fabric belt 3B serves as a second fabric belt. A path along which the coagulated soymilk T is held and conveyed by the conveyor 2A, the conveyor 2B, the fabric belt 3A, and the fabric belt 3B serves as the conveyance passage 4.

The conveyor 2A is endless, and is provided above the conveyance passage 4 for the coagulated soymilk T. The conveyor 2B is endless and is provided below the conveyance passage 4 for the coagulated soymilk T. The conveyor 2A and the conveyor 2B form a pair.

The conveyor 2A is driven by a conveying roller 10 and circles along a predetermined track above the conveyance passage 4. The conveyor 2B is driven by a conveying roller 11 and circles along a predetermined track below the conveyance passage 4. The conveying roller 10 and the conveying roller 11 are each driven by a motor (not shown). The conveyor 2A and the conveyor 2B are driven to circle at a constant circling speed. In addition, multiple driven rollers 12 are disposed on the circular track of each of the conveyor 2A and the conveyor 2B. The driven rollers 12 are driven by the conveying roller 10 and the conveying roller 11.

A predetermined tension is applied to each of the conveyor 2A and the conveyor 2B by driven rollers 12. That is, each of the conveyor 2A and the conveyor 2B are guided by the driven rollers 12. The driven rollers 12 act as tension rollers. This prevents deflection of the track of the conveyor 2A and the conveyor 2B, and adjusts the conveyor 2A and the conveyor 2B so that they circle along a predetermined track. Note that the method for applying tension to the conveyor 2A and the conveyor 2B is not limited to the above.

Furthermore, as shown in FIG. 10, the conveyor 2B is supported by multiple support rails 15 erected on a base stage 14 so as to be movable in a conveying direction P. Above the base stage 14, there is disposed an elevating unit 16 that is supported by an elevating mechanism (not shown) so as to be movable up and down. Multiple support rails 17 are provided to be hung down from the elevating unit 16, uniformly pressing the conveyor 2A downward toward the coagulated soymilk T. Note that there may be a configuration such that the conveyor 2B presses the coagulated soymilk T upward.

The conveyor 2A and the conveyor 2B are, for example, caterpillar-type conveyors, and are configured with a large number of flat plates and chains in combination. Note that the configuration of the conveyor 2A and the conveyor 2B is not limited to the above.

The fabric belt 3A is endless and is provided above the conveyance passage 4 for the coagulated soymilk T. The fabric belt 3B is endless and is provided below the conveyance passage 4 for the coagulated soymilk T. The fabric belt 3A and the fabric belt 3B form a pair.

The fabric belt 3A is driven by a drive roller 21 and circles on a predetermined track above the conveyance passage 4. The fabric belt 3A circles around the outer circumference of the conveyor 2A in synchronization with the conveyor 2A. The fabric belt 3B is driven by a drive roller 22 and circles on a predetermined track below the conveyance passage 4. The fabric belt 3B circles around the outer circumference of the conveyor 2B in synchronization with the conveyor 2B. The drive roller 21 and the drive roller 22 are each driven by a motor (not shown). Multiple driven rollers 13 are disposed on the circular track of each of the fabric belt 3A and the fabric belt 3B. The driven rollers 13 are driven by the drive roller 21 and the drive roller 22.

A predetermined tension is applied to each of the fabric belt 3A and the fabric belt 3B by the driven rollers 13. In other words, the fabric belts 3A and 3B are respectively guided by their respective driven rollers 13. The driven rollers 13 act as tension rollers. This prevents deflection of the track of each of the fabric belt 3A and the fabric belt 3B, and adjust the fabric belt 3A and the fabric belt 3B to circle along the predetermined track. Note that the method for applying tension to the fabric belt 3A and the fabric belt 3B is not limited to the above.

In the circular tracks of the conveyor 2A, the conveyor 2B, the fabric belt 3A, and the fabric belt 3B, the tracks of the individual members are positioned linearly along the conveyance passage 4 in a region forming the conveyance passage 4. In this way, the conveyor 2A and the conveyor 2B each include a track parallel to the conveyance passage 4. Furthermore, the fabric belt 3A and the fabric belt 3B each include a track parallel to the conveyance passage 4. From the entrance to the exit of the conveyance passage 4, the conveyor 2A, the conveyor 2B, the fabric belt 3A, and the fabric belt 3B are each positioned linearly.

The conveyor 2A, the conveyor 2B, the fabric belt 3A, and the fabric belt 3B hold the coagulated soymilk T, which is the object to be conveyed, in the up-down direction, and convey the coagulated soymilk T in the conveying direction P. Specifically, the conveyor 2A and the fabric belt 3A hold the coagulated soymilk T from above, while the conveyor 2B and the fabric belt 3B hold the coagulated soymilk T from below. That is, one surface of the fabric belt 3A is brought into contact with the surface of the conveyor 2A, and the other surface of the fabric belt 3A is brought into contact with the coagulated soymilk T. Also, one surface of the fabric belt 3B is brought into contact with the surface of the conveyor 2B, and the other surface of the fabric belt 3B is brought into contact with the coagulated soymilk T. In this way, the fabric belt 3A and the fabric belt 3B are provided between the pair of conveyors 2A and 2B, with the conveyance passage 4 interposed between them. The conveyance passage 4 is then formed between the fabric belt 3A and the fabric belt 3B.

As a result, the coagulated soymilk T is conveyed while being compressed on the conveyance passage 4. By compressing the coagulated soymilk T, water is squeezed out by the fabric belt 3A and the fabric belt 3B, and the water is discharged from the coagulated soymilk T. The coagulated soymilk T is then compacted and formed into tofu. For example, the discharged water may be whey, clear water, hot water, and the like. By continuously compressing the supplied coagulated soymilk T, sheet-shaped tofu of the predetermined formed size are produced.

Tofu includes silken tofu (soft tofu) and cotton tofu (firm tofu). Firm tofu includes tofu ranging from soft cotton tofu to firm cotton tofu, hard tofu, and dried tofu. The tofu may be soft cotton tofu, tofu bars, dough for fried bean curd (thick deep-fried tofu), dough for fried bean curd made of silken tofu, deep-fried bean curd or thick deep-fried tofu, dough for deep-fried bean curd such as seasoned deep-fried bean curd for sushi, dough for fried bean-curd cakes containing vegetables and other ingredients, and secondary processed products thereof. Secondary processed products may also include frozen and freeze-dried products.

The conveyor 2A, the conveyor 2B, the fabric belt 3A, and the fabric belt 3B each change the track at the exit of the conveyance passage 4 and return to the entrance of the conveyance passage 4 to form a circular track. In other words, the circular tracks are each formed of a conveyor track that conveys the coagulated soymilk T and a return track that returns from the exit side to the entrance side.

On the return track, each of the conveyor 2A, the conveyor 2B, the fabric belt 3A, and the fabric belt 3B is cleaned and sterilized. The continuous forming device 1 is provided with alkali cleaning baths 31, acid cleaning baths 32, and steam sterilization baths 33 on the return tracks. The alkali cleaning baths 31, the acid cleaning baths 32, and the steam sterilization baths 33 may be omitted.

The conveyor 2A, the conveyor 2B, the fabric belt 3A, and the fabric belt 3B, which have entered the return track, are cleaned in water cleaning units 34. The water cleaning units 34 spray cleaning water to remove remaining coagulated soymilk T, whey, and the like adhering to the conveyor 2A, the conveyor 2B, the fabric belt 3A, and the fabric belt 3B. The conveyor 2A, the conveyor 2B, the fabric belt 3A, and the fabric belt 3B then enter the alkali cleaning baths 31. The alkali cleaning baths 31 immerse the conveyor 2A, the conveyor 2B, the fabric belt 3A, and the fabric belt 3B in alkali solution, and break down organic matter such as oil and protein and perform the cleaning.

Then, the conveyor 2A, the conveyor 2B, the fabric belt 3A, and the fabric belt 3B are cleaned with water in water cleaning units 35. The water cleaning units 35 spray cleaning water to remove remaining coagulated soymilk T, whey, and the like adhering to the conveyor 2A, the conveyor 2B, the fabric belt 3A, and the fabric belt 3B. Furthermore, the water cleaning units 35 also cleans away alkali solution adhering to the conveyor 2A, the conveyor 2B, the fabric belt 3A, and the fabric belt 3B. The conveyor 2A, the conveyor 2B, the fabric belt 3A, and the fabric belt 3B then enter the acid cleaning baths 32. The acid cleaning baths 32 immerse the conveyor 2A, the conveyor 2B, the fabric belt 3A, and the fabric belt 3B in acid solution to dissolve inorganic salts (scale) such as calcium carbonate and perform the cleaning. Furthermore, the alkali solution adhering to the conveyor 2A, the conveyor 2B, the fabric belt 3A, and the fabric belt 3B is neutralized in the acid cleaning baths 32.

Then, the conveyor 2A, the conveyor 2B, the fabric belt 3A, and the fabric belt 3B are cleaned with water in water cleaning units 36. The water cleaning units 36 spray cleaning water to remove remaining coagulated soymilk T, whey, and the like adhering to the conveyor 2A, the conveyor 2B, the fabric belt 3A, and the fabric belt 3B. Furthermore, the water cleaning units 36 also cleans away acid solution adhering to the conveyor 2A, the conveyor 2B, the fabric belt 3A, and the fabric belt 3B. The conveyor 2A, the conveyor 2B, the fabric belt 3A, and the fabric belt 3B then enter the steam sterilization baths 33. The steam sterilization baths 33 sprays steam onto the conveyor 2A, the conveyor 2B, the fabric belt 3A, and the fabric belt 3B to sterilize them. Furthermore, the steam sterilization baths 33 also heat and sterilize the conveyor 2A, the conveyor 2B, the fabric belt 3A, and the fabric belt 3B with the internal heat. Acid solution adhering to the conveyor 2A, the conveyor 2B, the fabric belt 3A, and the fabric belt 3B is removed in the steam sterilization baths 33.

The conveyor 2A, the conveyor 2B, the fabric belt 3A, and the fabric belt 3B are cleaned in the return track, return to the entrance side of the conveyance passage 4, enter the conveyor track, and again convey and compress the coagulated soymilk T.

### Modifications

Note that the present disclosure is not limited to the above-described embodiment. In other words, designs obtained by appropriately modifying the above specific examples by a person skilled in the art are also within the scope of the present disclosure as long as they include the features of the present disclosure. Furthermore, the elements of the above embodiment and the following modifications can be combined to the extent technically possible, and such combinations are also within the scope of the present disclosure as long as they include the features of the present disclosure.

For example, while the above embodiment shows a specific configuration example of the continuous forming device 1, the specific device configuration is not limited to the configuration of the continuous forming device 1 shown in FIG. 9, as long as the apparatus is capable of continuously forming tofu.

Furthermore, the above embodiment has been described showing specific circular tracks for the conveyor 2A, the conveyor 2B, the fabric belt 3A, and the fabric belt 3B, but the circular tracks are not limited to those shown in FIG. 9.

1. A tofu manufacturing apparatus comprising:
a coagulation machine that produces coagulated soymilk that is tofu dough;
a cutting unit that cuts the coagulated soymilk in the coagulation machine into a polyhedral shape;
a conveying machine that conveys the coagulated soymilk downstream, the coagulated soymilk having been cut into a polyhedral shape by the cutting unit;
a collapse prevention unit that is provided in at least one of the coagulation machine and the conveying machine and prevents collapse of the coagulated soymilk; and
a forming machine that compression-forms the coagulated soymilk conveyed from the conveying machine.

2. The tofu manufacturing apparatus according to claim 1,
wherein the collapse prevention unit has an electric actuator or a hydraulic or pneumatic actuator that tilts the coagulation machine to discharge the coagulated soymilk in the coagulation machine onto the conveying machine, and the actuator is capable of controlling a tilt speed in accordance with a tilt angle of the coagulation machine.

3. The tofu manufacturing apparatus according to claim 2,
wherein the actuator tilts the coagulation machine at a faster tilting speed before the coagulated soymilk in the coagulation machine is discharged, and tilts the coagulation machine in multiple stages at a slower tilting speed once the coagulated soymilk in the coagulation machine begins to be discharged, to control a discharge speed of the coagulated soymilk.

4. The tofu manufacturing apparatus according to claim 1,
wherein the collapse prevention unit has a hopper provided on the conveying machine, and the hopper has an inclined surface that receives the coagulated soymilk discharged from the coagulation machine, the inclined surface having an inclination angle that increases from downstream to upstream in a conveying direction.

5. The tofu manufacturing apparatus according to claim 2,
wherein the collapse prevention unit has a hopper provided on the conveying machine, and the hopper has an inclined surface that receives the coagulated soymilk discharged from the coagulation machine, the inclined surface having an inclination angle that increases from downstream to upstream in a conveying direction.

6. The tofu manufacturing apparatus according to claim 3,
wherein the collapse prevention unit has a hopper provided on the conveying machine, and the hopper has an inclined surface that receives the coagulated soymilk discharged from the coagulation machine, the inclined surface having an inclination angle that increases from downstream to upstream in a conveying direction.

7. The tofu manufacturing apparatus according to claim 4,
wherein the collapse prevention unit includes a rotary pump connected to a discharge outlet of the hopper, and conveys the coagulated soymilk to the forming machine using a pressure of the rotary pump.

8. The tofu manufacturing apparatus according to claim 7,
wherein the collapse prevention unit has a conveying pipe having one end connected to the rotary pump and another end reaching the forming machine.

9. The tofu manufacturing apparatus according to claim 8,
wherein the conveying pipe includes a food-grade hose, a bend pipe, and a straight pipe.

10. The tofu manufacturing apparatus according to claim 8,
wherein the coagulation machine, the conveying machine, and the forming machine are positioned adjacently to one another to have a configuration such that the conveying pipe is relatively short.

11. The tofu manufacturing apparatus according to claim 4,
wherein the collapse prevention unit has a chute included in the conveying machine, and the chute delivers the coagulated soymilk discharged from the coagulation machine to the hopper.

12. The tofu manufacturing apparatus according to claim 1,
wherein the cutting unit has a lattice-shaped vertical cutter that vertically cuts the coagulated soymilk in the coagulation machine, and a horizontal cutter that horizontally cuts the coagulated soymilk.

13. The tofu manufacturing apparatus according to claim 2,
wherein the cutting unit has a lattice-shaped vertical cutter that vertically cuts the coagulated soymilk in the coagulation machine, and a horizontal cutter that horizontally cuts the coagulated soymilk.

14. The tofu manufacturing apparatus according to claim 3,
wherein the cutting unit has a lattice-shaped vertical cutter that vertically cuts the coagulated soymilk in the coagulation machine, and a horizontal cutter that horizontally cuts the coagulated soymilk.

15. The tofu manufacturing apparatus according to claim 1,
wherein the coagulation machine is a round-type bucket coagulation machine in which multiple coagulation buckets circle around a base stage.

16. The tofu manufacturing apparatus according to claim 2,
wherein the coagulation machine is a round-type bucket coagulation machine in which multiple coagulation buckets circle around a base stage.

17. The tofu manufacturing apparatus according to claim 3,
wherein the coagulation machine is a round-type bucket coagulation machine in which multiple coagulation buckets circle around a base stage.

18. The tofu manufacturing apparatus according to claim 1,
wherein the forming machine is a continuous forming device that compression-forms coagulated soymilk supplied to a conveyance passage.

19. The tofu manufacturing apparatus according to claim 2,
wherein the forming machine is a continuous forming device that compression-forms coagulated soymilk supplied to a conveyance passage.

20. The tofu manufacturing apparatus according to claim 3,
wherein the forming machine is a continuous forming device that compression-forms coagulated soymilk supplied to a conveyance passage.
